(19) United States
(12) Patent Application Publication
(10) Pub. No.: US 2026/0228585 A1
(43) Pub. Date: Aug. 6, 2026

(54) CRYOGENIC HARDWARE BASED PHASE CONTROL WITH CLASSICAL MONITORING OF PHASE NOISE ERRORS IN QUANTUM CIRCUITS

(71) Applicant: Dell Products L.P., Round Rock, TX (US)

(72) Inventors: Tejinder Singh, Manotick (CA); Navjot Kaur Khaira, Manotick (CA); Brendan Healy, Haddonfield, NJ (US); Romulo Teixeira de Abreu Pinho, Niterói (BR)

(21) Appl. No.: 19/045,473

(22) Filed: Feb. 4, 2025

(51) Int. Cl. G06N 10/40

(52) U.S. Cl. CPC G06N 10/40

(57) ABSTRACT

The technology described herein is directed towards monitoring phase noise errors in quantum circuits via a classical (non-quantum) computing device, along with phase control based on the monitoring. A phase shifter, operating at cryogenic temperatures, is deployed between a microwave photon source and the qubits to ensure precise phase alignment. By placing the phase shifter in close proximity to the qubits, the system reduces thermal noise and increases coherence during quantum gate operations, thus improving overall quantum computation performance. The classical computing device monitors the phase of the qubits following qubit interaction with a microwave signal from the photon source, detecting any deviations or noise-induced errors. Based on the monitored phase, the computing device adjusts the phase of subsequent microwave signals in real time via control of the phase shifter to mitigate phase noise, thereby reducing phase drift and noise, which ensures better stability and fidelity of qubit operations.

### BACKGROUND

Quantum circuits perform highly-sensitive operations where even small amounts of noise, e.g., phase noise, can lead to significant errors during qubit manipulation. Traditional quantum systems, where signals from the photon source directly interact with the qubit chain, are particularly vulnerable to noise, resulting in decoherence and reduced gate fidelity. As quantum operations require long periods of coherence, errors introduced by noise and/or other environmental factors can accumulate, compromising quantum gate operations.

### BRIEF DESCRIPTION OF THE DRAWINGS

The technology described herein is illustrated by way of example and not limited to the accompanying figures in which like reference numerals indicate similar elements and in which:

FIG. 1 is a block diagram representation of an example a hybrid-classical quantum system in which a phase shifter is deployed in a dilution refrigerator before a qubit chain to add defined phase shift from a classical (non-quantum) computing device/node, in accordance with various example embodiments and implementations of the subject disclosure.

FIGS. 2 and 3 depict an example hybrid classical-quantum system for controlling and measuring qubit operations, including via selectively applied variable phase shifts to qubits via a cryogenic phase shifter, in accordance with various example embodiments and implementations of the subject disclosure.

FIG. 4 is a conceptual representation of a quantum computer including a dilution refrigerator with qubits and a cryogenic phase shifter operating at qubit temperatures, in accordance with various example embodiments and implementations of the subject disclosure.

FIG. 5 is a top view representation of an example reflective-type phase shifter suitable for use with the quantum hardware of FIGS. 1-4, with signal input from a classical microwave source and phase-shifted output directed to the qubits, in accordance with various example embodiments and implementations of the subject disclosure.

FIG. 6 is a representation of the layout of the example reflective-type phase shifter of FIG. 5, showing radio-frequency superconducting quantum interference devices (RF-SQUIDs) for tunable phase shift control and reflective loads incorporating capacitors and inductors, in accordance with various example embodiments and implementations of the subject disclosure.

FIG. 7 is a three-dimensional representation of the layout of the example reflective-type phase shifter of FIGS. 5 and 6, highlighting a quadrature coupler, crossovers, and placement of the RF-SQUIDs, in accordance with various example embodiments and implementations of the subject disclosure.

FIG. 8 is a three-dimensional view representation of the layout of the example reflective-type phase shifter of FIGS. 5-7, including zoomed in views of parts of the layout, in accordance with various example embodiments and implementations of the subject disclosure.

FIG. 9 is an example multi-layer stack designing for the example phase shifter, in accordance with various example embodiments and implementations of the subject disclosure.

FIG. 10 is a plot of simulated relative phase shift versus frequency for one example phase shifter, showing phase shift tunability with sourced current ranging from zero milliamps (mA) to four mA, in accordance with various example embodiments and implementations of the subject disclosure.

FIG. 11 is a flow diagram showing example operations related to controlling a photon source and a phase shifter based on monitoring state information of a qubit, in accordance with various example embodiments and implementations of the subject disclosure.

### DETAILED DESCRIPTION

The technology described herein is generally directed towards a cryogenic phase control system integrated with a classical monitoring system to mitigate phase noise errors in quantum gate operations. A phase shifter, operating at cryogenic temperatures (e.g., T~10 milli-Kelvin (mK) or even lower, e.g., T=<4 K), is introduced between the photon source and the qubit chain to ensure relatively very precise phase alignment. The classical control node continuously monitors the phase, detecting any deviations or noise-induced errors, and can adjust the phase control system in real time, based on any detected phase drift and/or phase noise. This significantly reduces phase drift and noise, ensuring higher stability and fidelity of qubit operations. By placing the phase shifter in close proximity to the qubits (e.g., T≈mK), or even monolithically integrated on a qubit chip, the system minimizes thermal noise and maximizes coherence during quantum gate operations, thus improving overall quantum computation performance.

As set forth herein, traditional quantum systems are particularly vulnerable to phase noise, resulting in decoherence and reduced gate fidelity. As quantum operations require long periods of coherence, phase errors introduced by thermal noise or environmental factors can accumulate, compromising the effectiveness of quantum gate operations.

Described herein is the integration of a cryogenic phase shifter within the quantum circuit. Positioned between the photon source (T=293 K) and the qubit chain (T can be on the order of mK), the phase shifter can operate at cryogenic temperatures (T=<4 K), ensuring that the signals interacting with the qubits are properly aligned and phase-controlled. The classical computing device (control node) monitors the phase of the signals. Any phase errors or noise deviations are detected by the computing device, which adjusts the phase shifter in real time to maintain optimal signal alignment. This integration of classical monitoring for error detection, combined with cryogenic phase control, mitigates the adverse effects of phase noise, and ensures that qubits maintain coherence for extended periods, significantly improving the performance and stability of quantum computations.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

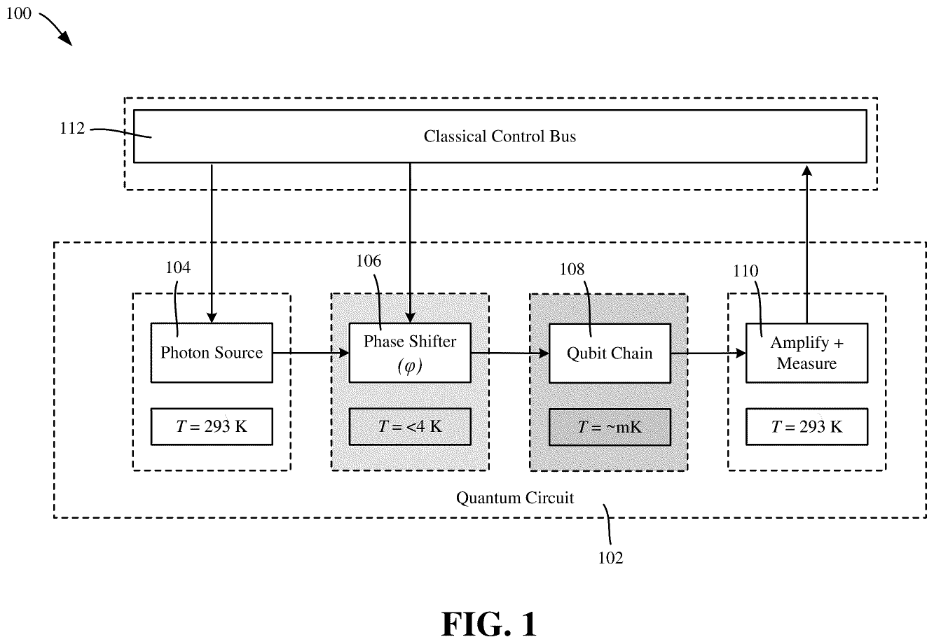

FIG. 1 is a generalized representation of an example hybrid classical-quantum system 100 that includes a quantum circuit 102 in which a photon source 104, phase shifter, qubit chain 108, and measurement setup (block 110) interact with the benefit of intermediate phase control as described herein. Note that this is in contrast to existing quantum circuits/systems, in which there is no phase control, making the qubits vulnerable to phase noise, thermal drift, or other forms of signal degradation; indeed, any misalignment in the phase of the signals can lead to errors in qubit manipulation, reducing gate fidelity.

The photon source 104 generates the microwave signals used to manipulate qubits, as controlled by the computing device (the control bus 112 of which is shown in FIG. 1); the temperature at this stage is room temperature (e.g., around 293 K). The phase shifter 106 operates at cryogenic temperatures (below 4 K in this example). The phase shifter 106 adjusts the phase of the microwave signals before they interact with the qubits of the qubit chain 108. The placement at cryogenic temperatures helps reduce phase drift caused by thermal noise.

The qubit chain 108 includes qubits that are maintained at extremely low temperatures (millikelvin range) to ensure their stability/coherence during quantum gate operations. The signals from the photon source interact directly with the qubits, manipulating their quantum states. After interacting with the qubits, the signal is amplified and measured (block 110) at room temperature; the amplified and measured signals are processed at room temperature by the classical computing device.

As set forth herein, maintaining phase coherence facilitates the stable operation of qubits during quantum gate operations. The cryogenic phase shifter 106 deployed between the photon source 104 and the qubit chain 108 facilitates the control and adjustment of the phase of the microwave signals that interact with the qubits. The placement of the phase shifter at cryogenic temperatures (T=<4 K) ensures the system is less susceptible to thermal noise, which can induce phase drift and cause errors in qubit operations. The photon source 104, operating at room temperature (T=293 K), generates microwave signals that pass through the cryogenic phase shifter 106 before reaching the qubits/qubit chain 108, which are housed in an even colder environment (T≈mK) to maintain coherence.

Further, the integration of the classical computing device (control node) monitors the phase of the signals in real time, to detect any phase noise errors or deviations that arise due to external environmental factors or hardware imperfections. Because quantum gate operations are extremely sensitive to such phase variations, the classical computing device compares the phase of the incoming signals as measured and flags any discrepancies (phase deviations) from what the phase shift should be without noise errors or the like. Upon detecting phase deviations, the control node dynamically adjusts the phase shifter 106 to correct the signal's phase before it interacts with the qubit chain, thereby minimizing the impact of phase noise on qubit operations.

Note that temperature control is a significant part of the quantum portion of the system, as different components operate at significantly different temperature levels to minimize noise and maintain coherence. The quantum processor operates at extremely low temperatures, with the qubit chain at 10 mK or below, and the signal amplifier at 30 mK. These temperatures maintain superconductivity and prevent thermal noise from disrupting the delicate quantum states. The flux sensing and phase control lines that interact with the qubits are also cooled down to 1 K to ensure minimal noise and stable control of the quantum operations. The classical control components, such as the microwave photon source, SMU, ADC, DAC, and HPC cluster, operate at room temperature (around 293 K). These components handle the classical data processing and control signals that drive the quantum system.

Via the phase control and classical monitoring feedback loop, the system effectively mitigates phase noise, ensuring that the signals interacting with the qubits are phase-aligned and coherent throughout the gate operations. The cryogenic placement of the phase shifter minimizes thermal noise and drift, further enhances the system's ability to maintain phase coherence. The combination of real-time phase control and error monitoring by the classical node ensures that qubits remain stable during computation, resulting in higher-fidelity quantum gate operations and improved overall performance of the quantum system. The technology described herein thus overcomes a significant challenge in quantum computing, namely preserving qubit coherence and reducing phase-related errors during critical operations.

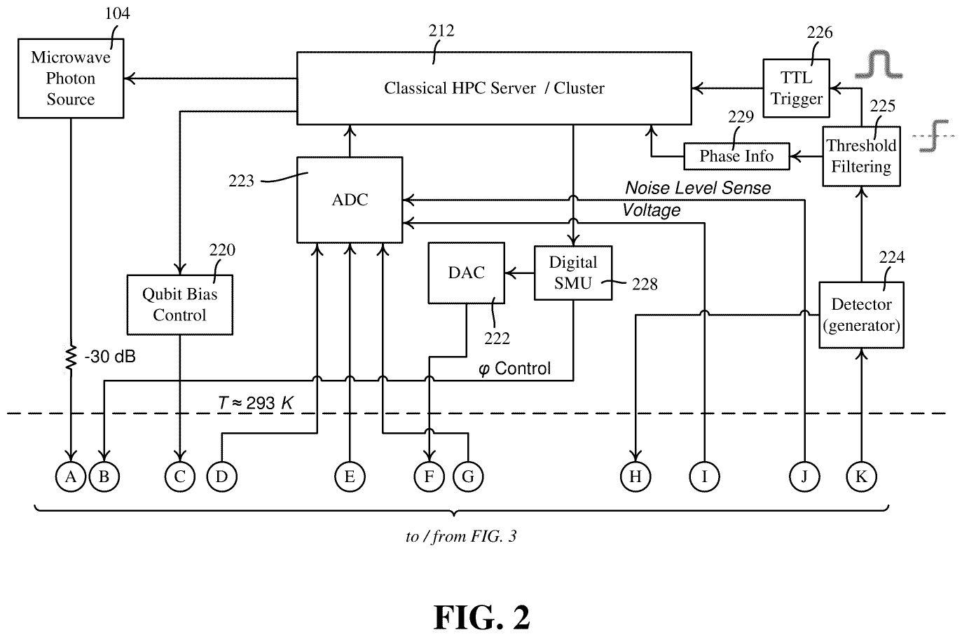

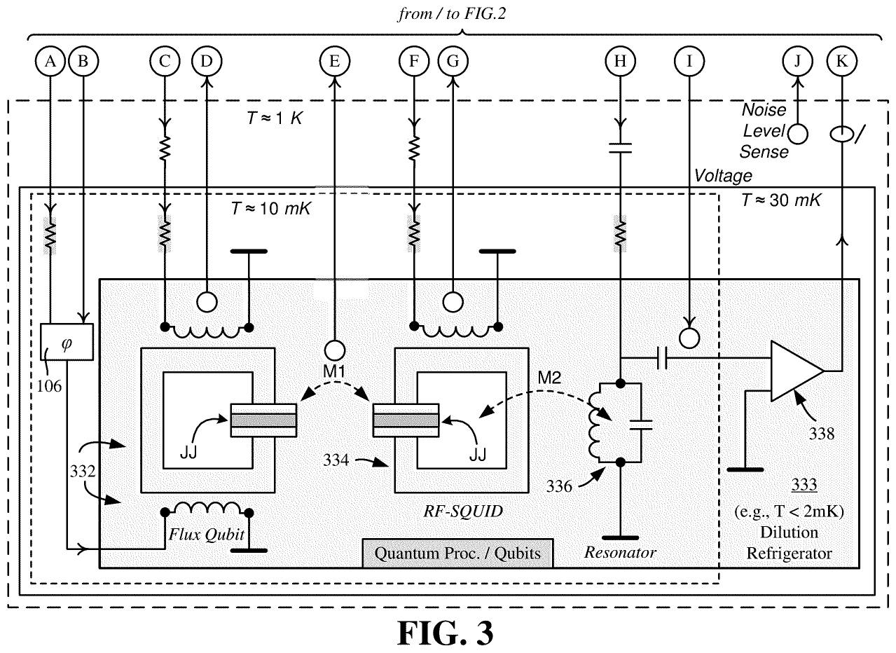

FIGS. 2 and 3 comprise a block diagram representation of an example quantum processor measurement and control setup/environment, in which qubit control and readout is facilitated by integrating a classical high-performance computing server/cluster 212 (FIG. 2) with a quantum computing system having a quantum processor and qubits 332 (FIG. 3) near the base plate of a dilution refrigerator 333, on the order of 2 milli-Kelvin (mK).

The representation of FIG. 3 thus shows an example architecture of a quantum system with a focus on cryogenic control and signal processing. The overall system 100 (e.g., summarized in FIG. 1) integrates classical control components (FIG. 2) and quantum hardware (FIG. 3) to ensure the proper manipulation and measurement of qubits, with an emphasis on temperature management to maintain the coherence of quantum operations. As generally shown in FIG. 3, the quantum hardware is housed within the dilution refrigerator 333, ensuring ultra-low temperatures for stable qubit operations. In one implementation, the quantum portion (FIG. 2) of the hybrid system 100 (FIG. 1) operates with a combination of flux qubits, RF-SQUIDs (radio frequency-superconducting quantum interference devices), and a resonator, each contributing to the manipulation and control of quantum states.

In general, a flux qubit is a type of qubit that operates based on superconducting loops in which the current can circulate in both clockwise and counterclockwise directions, representing quantum superposition. The qubit (e.g., 332) is housed at a temperature of 10 mK or below (e.g., 2-4 mK), which helps maintain coherences and prevent decoherence due to thermal noise.

The RF-SQUIDs are superconducting circuits used to control the coupling between qubits. The RF-SQUIDs allow manipulation of quantum states by providing a tunable inductive coupling between the qubits. The Josephson junctions (JJ) in the RF-SQUIDs enable quantum tunneling, which is a core part of quantum operations in superconducting qubits. The magnetic interaction between the RF-SQUIDs (represented by M1), and between the RF-SQUID 334 and the resonator 336 (represented by M2), can adjust the energy levels and state transitions of the qubits.

The resonator 336 is coupled to the qubits, providing a device to read out the qubit states. By measuring the resonance frequency shifts, the state of the qubits can be inferred, allowing for quantum state measurements. After interacting with the qubits, the signal is passed through a cryogenic amplifier 338, e.g., operating at around 30 mK. Amplifying the signal in such a low-temperature environment ensures that noise is kept to a minimum before the signal is sent for classical processing. The amplifier 338 helps to boost the weak quantum signals for subsequent measurement without introducing significant noise that could affect accuracy.

As shown in FIG. 2, the example classical (non-quantum) portion of the hybrid system 100 (FIG. 1) includes the microwave photon source 104, which is controlled by the classical high-performance compute (HPC) server/cluster 212, both operating at room temperature (around 293 K). As described herein, the classical system portion interfaces with the quantum hardware to drive, control, and measure qubit operations. More particularly and as will be understood, the server/cluster 212 processes the data from the quantum hardware, including measurements from the qubits, and can also provide real-time feedback for qubit control, adjusting the parameters, including the phase shifter 106, based on the measured outcomes to optimize the quantum operations.

The microwave photon source 104 generates microwave signals that interact with the qubits. The microwave source 104 feeds microwave signals through coaxial cables into the quantum hardware. The microwave signals are controlled to ensure precise phase, amplitude, and timing, as is appropriate for quantum gate operations. The microwave photons from the microwave photon source 104 go through multiple temperature stages to reach the flux qubits (e.g., 332) in the dilution refrigerator 333.

At each stage, along with the reducing temperature, the microwave signal is heavily attenuated as qubits are provided very low-power microwave photons. Note that the HPC server/cluster 212 can control operation of the photon source 104 in terms of pulses, e.g., the sequence of pulses, the width and voltage of the pulses and the like can be controlled by the classical server/cluster 212; any amount of gates can be applied to the qubit, to control the qubit and configure the qubit, including as described herein.

A qubit bias control component (block 220, FIG. 2) provides precise magnetic flux control to the qubits. Adjusting the magnetic flux through the superconducting loops enables the fine-tuning of the qubit states. This control system operates at room temperature but communicates with the cryogenic quantum hardware through superconducting lines. The qubit bias control can be in the form of a constant voltage or current to adjust the energy levels of the qubit, and can be provided from the classical HPC server/cluster 212. A change in the magnetic flux in the qubit 332 (FIG. 3, after absorption of a photon) induces a change in the mutual flux coupling (M1) with an RF-SQUID M2, which in general acts as a detector controlled by the server/cluster 212, e.g., via a digital-to-analog converter 222. The RF-SQUID 336 includes a superconducting loop across a Josephson Junction (JJ) characterized by its critical current (IC), capacitance (C), and shunt resistance (R).

Note that in general, the digital-to-analog converter (DAC) along with an analog-to-digital converter (ADC) 223 translates between the digital signals used for classical computation and the analog signals used in the quantum hardware. The DAC 222 generates precise analog control signals for driving qubit operations, while the ADC 223 digitizes the analog signals received from the qubit measurement. These converters operate at room temperature.

To register signals in RF-SQUIDs, a readout resonator/LC (inductor-capacitor) tank circuit 334 is used, including an inductor (L_{T}) and a capacitor (C_{T}), which together oscillate at a natural frequency ω_{T}/2π=½π\sqrt{(L_{T}C_{T})}. The resonator 336 is designed to be sensitive to small changes in magnetic flux, mutually coupled (M2) to the RF-SQUID 334, as appropriate for detecting photon interactions with the qubit. An external pumping current I_{rf} sin(ω_{P}t) is provided (via labeled circle “G”) from a detector/generator 224 (FIG. 2) at frequency Ω/2π, which is very close to the natural frequency of the LC tank circuit resonator 336 (ω_{P}−ω_{T})/ω_{T}<<1 and quality factor Q>>1. The current/voltage bias (block 106) to the RF-SQUID 336 is very accurate to not (inadvertently) operate the RF-SQUID M2 in non-hysteresis mode.

Note that FIG. 3 only shows components for two RF-SQUIDS/qubits, however any practical number may be present in a given quantum computing configuration. Further note that the resonator 336 can obtain a control signal, and because any voltage generates the magnetic flux, a qubit state change will occur, as the generated magnetic flux will break the entanglement, or it will collapse the qubit; the system can read that what was the recent data, such as how much frequency changed in the resonator 336.

The output from the LC tank/resonator 336 is very weak, and hence is amplified (signal amplifier 336) and provided to the detector 224 (FIG. 2), which further performs threshold filtering (block 225) to quantize the state of the qubit, and provides the transistor-transistor logic (TTL) trigger (block 226) to the classical server/cluster 212. In general, threshold filtering component, block 225, along with the detector 224, are part of the classical control system and fed to the PCIe interface, and are responsible for analyzing the output from the quantum hardware. The signals are passed through the threshold filter to remove noise and isolate the meaningful quantum information. The detector 224 then extracts the final measurement results from the filtered signals. The TTL trigger 226 is used for synchronizing operations within the classical system and with the quantum hardware. Precise timing of signals is used in quantum systems, and the TTL trigger 226 ensures that operations such as qubit state initialization, manipulation, and readout are synchronized.

To ensure accurate control, a PCIe card interface-based digital source measure unit (SMU) 228 can be used, such as a high-performance SMU that is commercially available. In general, a digital source measure unit (SMU) 228 provides precise voltage or current control for various elements in the quantum system. The SMU 228 ensures that bias voltages and other control parameters are stable, which maintains qubit fidelity. A high-performance PXI-based SMU (PCI eXtensions for Instrumentation) provides fast, precise dynamic measurements from DC to a 20 μs pulse, with outputs up to 210 V/315 mA, 10 femtoampere (fA) resolution, and the lowest source noise.

Similarly, a commercially available PXI-based digital-to-analog converter (DAC) 222 can be used, such as one that features sixteen simultaneous channels capable of supplying stimulus waveforms with output voltages ranging from 0V to +30V, and output currents from 0 mA to +20 mA. In one implementation, both the SMU 228 and DAC 222 are compatible with PCIe interfaces and can be housed in a PXI chassis, which saves rack space and reduces maintenance cost. Also shown in FIG. 2 is the analog-to-digital converter (ADC) 223 coupled to the classical server/cluster 212 and a number of sensors (the small circles at various tap points in FIG. 3, corresponding to the circled labels D, E, G, I and J).

To summarize, in one example implementation, the digital SMU 228 can control a phase shifter (φ) 106 (FIGS. 1-3) that can apply a phase shift to a qubit. Phase information (block 229, FIG. 2) can be provided to the classical server/cluster 212. Such phase information allows real-time phase tuning and repeated measurements to ensure accurate quantum state tracking and error correction, e.g., if small phase deviations are detected between the applied phase and the measured phase following execution of one or more operations on the qubit as described herein, the phase can be adjusted and the operations reattempted and remeasured.

Thus, as generally represented in FIG. 2, hardware for control and readout can, for example, include one or more advanced source measure units (SMUs) and analog-to-digital converters (ADCs), which can be managed more efficiently with classical systems, thereby reducing the number of physical components and vendor equipment otherwise needed. Such a hybrid system can be designed modularly, where each module, including multiple qubits and their respective control/readout lines, can be independently managed by one or more classical processors. Such modularity simplifies system scaling, allowing new modules to be added without redesigning the entire control infrastructure.

The technology described herein leverages the precise classical control of the qubit control and measurement operations. For example, a classical high-performance computing server (or cluster of such servers) with peripheral component interconnect express (PCIe-based) or the like control can use a source measure unit (SMU) for quantum computers with some practical number (e.g., one the order of dozens) of qubits, including to apply controlled phase shift and controlled rotation to a qubit.

Further, the technology described herein controls the qubit readout circuit using a source measure unit and digital-to-analog converter; this can provide ultra-precise control of readouts with ultra-low signals. The hybrid classical-quantum technology described herein is, in part, directed to recording a photon-induced transition in a flux qubit, for example. Note however that photons/flux qubits are only examples, as indeed, the technology described herein is agnostic to any particular type of qubit, and further, that probe signals other than those based on microwave photons can be used, as appropriate for a given type of qubit.

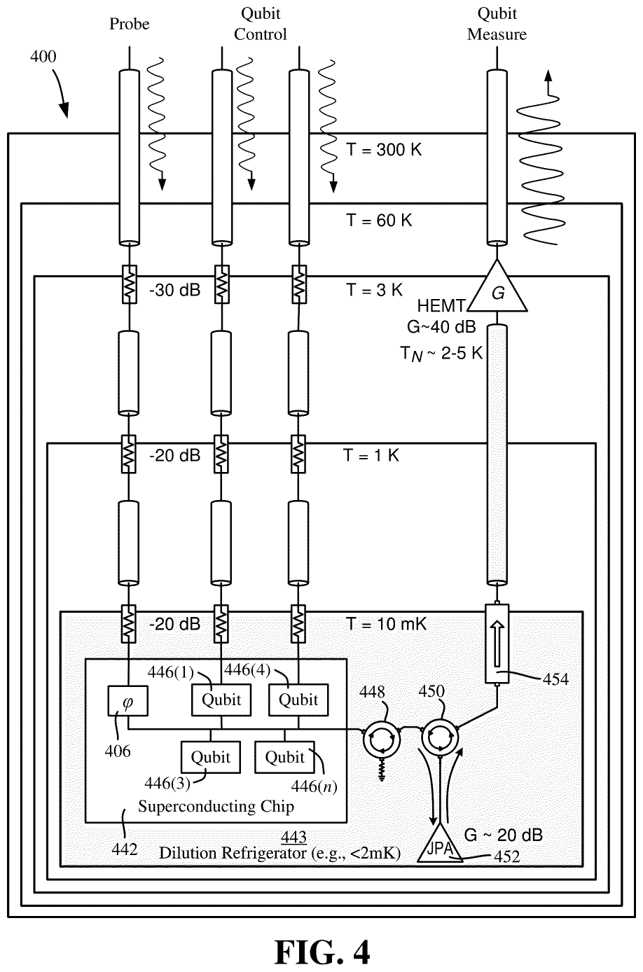

Further, in one or more example implementations, a phase shifter can be designed and monolithically integrated with a superconducting chip that integrates the qubits. FIG. 4 is a block diagram representation of an example quantum processor measurement and control setup/system 400 including a measurement and control setup for a superconducting quantum computing chip 442 near the base plate of a dilution refrigerator 443, on the order of 2-10 Kelvin (mK). Some number of qubits 446(1)-446(n) (four are depicted, but any practical number may be present) are fabricated on the superconducting quantum computing chip 442, along with a monolithically integrated phase shifter (φ) 406.

Also shown in FIG. 4 as part of the qubit measuring portion are circulators 448 and 450, a Josephson parametric amplifier (JPA) 452, an isolator 454 and a high electron mobility transistor (HEMT) G. In general, a probe signal that is a set of strongly attenuated microwave tones (<−120 dBm) is by injected via coaxial cables (depicted as unshaded cylinders) and attenuators to the qubits 406(1)-406(n) through the various levels of the quantum processor 400, resulting in a measurement signal being input via a readout line to a first port of the circulator 448. As described herein, the circulator 448 is configured for clockwise rotation, whereby the signal is routed to a second port (low insertion loss) and not the third port (high isolation, and coupled via resistor to ground), nor returned to the first port (low return loss). The second port is coupled to the input port of a second circulator 450 configured for counterclockwise rotation, such that the signal is routed to at least one Josephson parametric amplifier (JPA) 452, with the amplified measurement signal routed back to the output port of the circulator 450 though the isolator 454 to the HEMT G for further gain before measurement by one or more conventional RF devices (not explicitly shown). Note that the shaded cylinder shown in the measurement signal output path represents a superconducting coaxial cable. Based on the measurement results, qubit control signals can be sent to the qubits 406(1)-406(n).

Thus, each circulator is a nonreciprocal three-port device that allows signals to travel in only one predetermined direction among its three ports, whereby the qubit readout line uses such circulators 448 and 450 to provide isolation between different components so as to maintain the fidelity of the qubit readout. By isolating different parts of the readout circuit, circulators help in reducing noise that could otherwise affect the qubit's state and/or the accuracy of the readout. Multiple circulators are used in the quantum computing setup, ensuring that signals are correctly channeled to the appropriate destinations as shown in FIG. 4.

To summarize FIG. 4, the state of the superconducting qubits is probed, and the readout involves amplifying and delivering the measured result back to room temperature. The weak output signal from a qubit is amplified using one or more superconducting parametric amplifiers, such as Josephson parametric amplifiers (JPA), operating at 10 mK and semiconductor high electron mobility transistor (HEMT) amplifiers operating at 4 K. The RF circulators are used to protect the quantum circuit from reflections and noise; the probing, control, and readout of qubit systems involves a large amount of microwave hardware.

Microwave phase shifters are devices that adjust the phase of microwave photons, and are thus used in quantum computing, particularly in systems based on superconducting qubits. The phase of microwave signals is finely tuned to ensure precise control over qubit rotations, which are fundamental operations in quantum gates. Phase shifters enable such fine-tuning by adjusting the phase of the microwave photons. They are also used when performing controlled-phase gates, a type of quantum gate that operates by inducing a phase shift in the target qubit conditional on the state of the control qubit. Microwave phase shifters also play a role in multi-qubit operations, such as CNOT (Controlled NOT) and CZ (Controlled-Z) gates, providing phase alignment to maintain coherence and minimize errors. Additionally, quantum error correction and the sensitive readout of qubit states rely on microwave phase shifters. Their application extends to cryogenic microwave circuits, where they ensure signal integrity, preserving qubit coherence and the fidelity of quantum operations.

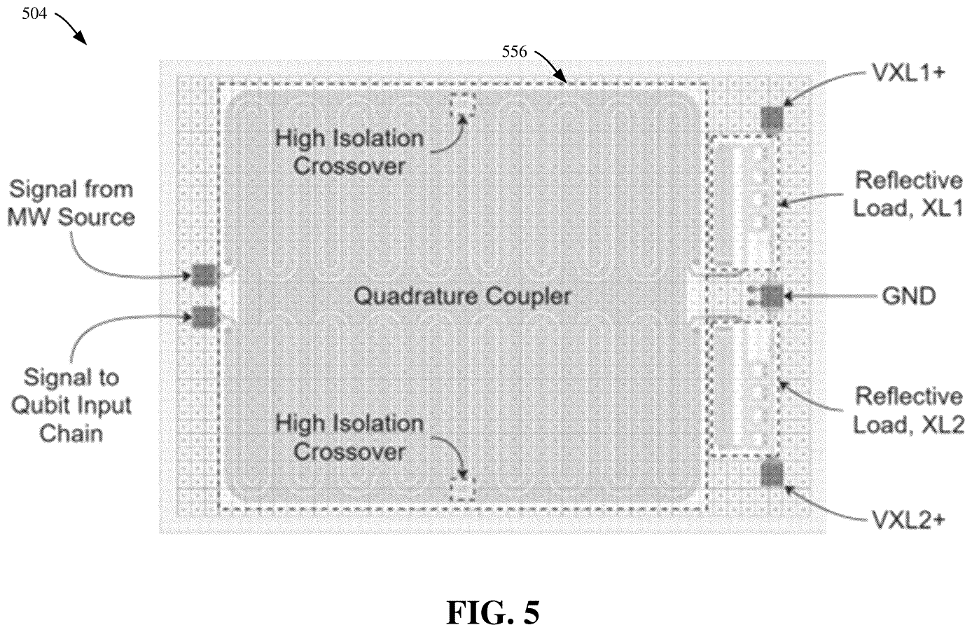

Turning to one example of a suitable microwave phase shifter 504 (FIGS. 5-9) for use at cryogenic temperatures, in general, one phase shifter 504 described herein is directed to a phase shifter with precise phase control based on radio-frequency superconducting quantum interference device (RF-SQUIDs)-based superconducting. The example device can be deployed in a dilution refrigerator, and indeed, as in FIG. 4, can be monolithically integrated on the same chip as the qubits, e.g., optimized for operation at extremely low cryogenic temperatures of around 2 mK.

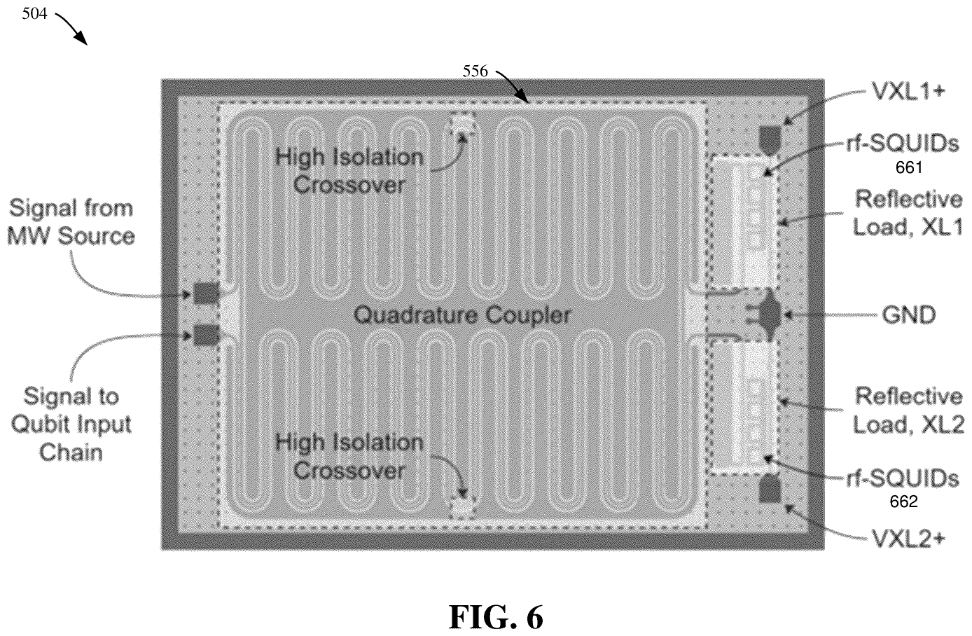

Described herein is a reflective-type topology for an example phase shifter 504 that incorporates a hybrid coupler 556 and two (e.g., identical) reflective loads XL1 and XL2, as shown in FIGS. 5 and 6. The hybrid coupler 556, also known as quadrature coupler, divides and can combine microwave signals. Note that typically the hybrid coupler is a ninety degrees (90°) hybrid coupler that divides an incoming microwave signal into a first, non-phase-shifted instance of the microwave signal, and a second, phase-shifted instance of the microwave signal that is 90° degrees phase shifted relative to the first, non-phase-shifted instance.

The example phase shifter design shown in FIGS. 5-8 employs a tandem coupled line approach for the hybrid coupler 556, using a coplanar waveguide (CPW) structure. Such a CPW-based hybrid coupler has two parallel coupled lines placed side by side, with high-isolation crossovers routed through a separate superconducting layer using inter-layer vias. Such multi-layer fabrication ensures that the crossovers of the tandem structure are isolated from the coupled lines, ensuring large isolation. The input microwave (MW) signal comes from the classical computer and the output is directed towards the qubits.

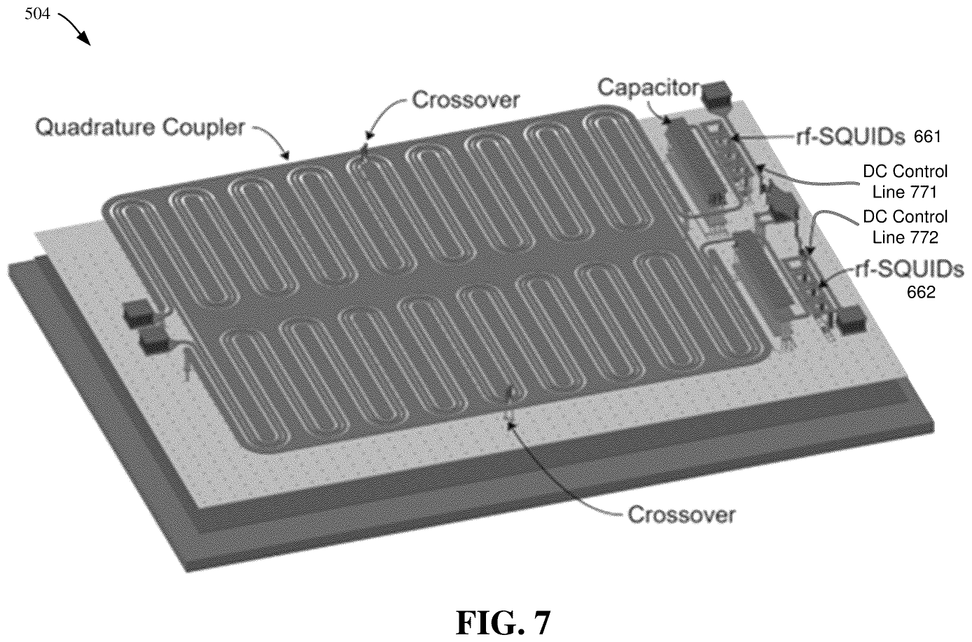

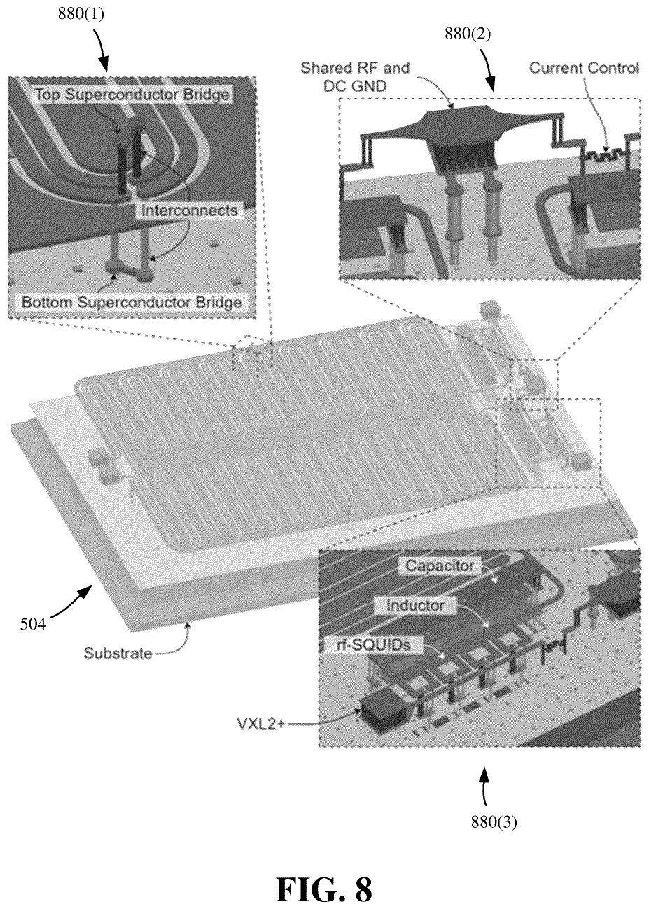

As shown in the three-dimensional (3D) views of FIGS. 7 and 8, each reflective load (e.g., XL1) is designed using a series connection of a metal-insulator-metal (MIM) capacitor and a microstrip inductor, with the microstrip inductor grounded at its free end. The microstrip is designed to ensure a characteristic impedance of fifty ohms relative to the ground plane. As shown in FIG. 6, sets of RF-SQUID 661 (for the reflective load XL1) and 662 (for the reflective load XL2) offer variable inductance when subjected to external magnetic flux from a nearby current line 771 and 772, respectively (FIG. 7), and are integrated alongside (and thereby inductively coupled to) the respective microstrip inductors of the respective reflective loads XL1 and XL2. These RF-SQUID sets 661 and 662 provide tunability for the load impedance and phase shift. As the inductance of a respective RF-SQUID set changes, so does the inductance of the respective microstrip inductor inductively coupled thereto, modulating the phase shift.

The microwave signal from the microwave source applied at the input port (FIGS. 5 and 6) of the hybrid coupler 556 undergoes a phase shift, which is then obtained at the output port and sent to qubit input chain. More particularly, the microwave signal at the input port is divided equally into two instances with 90° phase difference between them. Each of these split signals goes to a reflective load. The change in inductance in each reflective load determines the phase at the output port from the hybrid coupler, because the signals reflected from each reflective load interfere constructively at the output port. Hence, the phase shift is controlled by the current provided to the DC (direct current) control current line, which tunes the magnetic flux threading each RF-SQUID loop, and thereby the inductance of the inductors of each reflective load, modulating the phase shift between the input and output signals.

The respective DC current lines run parallel to the respective RF-SQUID sets 661 and 662, and the current in the line is controlled by the voltage applied at terminals VXL1 and VXL2 for reflective loads XL1 and XL2, respectively. These lines share a common ground. Each tunable reflective load's impedance, primarily determined by its imaginary component XL, and the reflection coefficient I, are influenced by the corresponding RF-SQUID set's inductance, which is controlled via the applied voltage.

The 3D view of the layout in FIG. 8 highlights some of key details of the design. A first zoomed-in section 880(1) highlights the interconnects (bridges) in the design that are routed from different superconducting layers in the fabrication stack, that is, above or below the primary layer of the hybrid coupler. A second zoomed-in section 880(2) shows the common ground plane for the two control lines for the RF-SQUIDs. In this example, each control line for controlling the inductance of an RF-SQUID set includes a current controlled device (the meandering conductor) that does not let the current exceed a certain level in the line. This is a protection device, as very high levels of current on the line lead to higher magnetic flux threading the RF-SQUIDs, which can damage their operation. In the example design, monolithically integrated current control devices in-built in the circuit is used, as shown in the zoomed-in section 880(2).

A third zoomed-in section 880(3) illustrates the arrangement of the MIM capacitors, microstrip inductors, and RF-SQUID sets in each reflective load.

To derive the expression for the change in inductance of the microstrip inductor (in the reflective load) when coupled with RF-SQUIDs, consider a microstrip unit cell, which in an equivalent circuit includes a shunt capacitance Cₘ and series inductance Lₘ, coupled to a superconducting loop with inductance L_{sq} and Josephson Junction (JJ) with inductance Lⱼ. The coupling between Lₘ and L_{sq} is defined by mutual coupling M1 and coupling coefficient K₁. Additionally, a microstrip control transmission line, monolithically integrated on-chip, runs parallel to the RF-SQUIDs. The unit inductance of this control microstrip transmission line L_{c} couples to the SQUID loop inductance L_{sq} with mutual inductance M₂ and coupling coefficient K₂.

$${K}_{1}^{2} = \frac{{M}_{1}^{2}}{{L}_{sq} {L}_{c}} ; \qquad ( 1 )$$

$${K}_{2}^{2} = \frac{{M}_{2}^{2}}{{L}_{sq} {L}_{c}} ;$$

The control current i_{dc} applied to the control line generates a magnetic field around the microstrip top conductor, inducing a geometrical flux φₑₓₜ in the SQUID loop:

$${ϕ}_{ext} = {M}_{2} {i}_{dc} \qquad ( 2 )$$

A circulating current i_{sq} is induced in the SQUID loop to screen this flux, due to flux quantization condition, leading to the total flux φ_{sq} in the loop:

$${ϕ}_{sq} = {ϕ}_{ext} + {L}_{sq} {i}_{sq} \qquad ( 3 )$$

The circulating supercurrent depends on the critical current I_{c} of the JJ and the total flux in the SQUID loop:

$${i}_{sq} = - {I}_{c} sin \frac{2 π {ϕ}_{sq}}{{ϕ}_{0}} \qquad ( 4 )$$

where φ₀ is the flux quantum (φ₀=2.0679×10⁻¹⁵ Wb) and I_{c} is determined by the area of the junction A and the current density J_{c} of the junction. The behavior of the SQUID is characterized by the screening parameter of RF-SQUID given by:

$$β = \frac{2 π {L}_{sq} {I}_{c}}{{ϕ}_{0}} \qquad ( 5 )$$

For this application, the condition β<1 is satisfied, and the internal flux in the SQUID increases monotonically with the external flux φₑₓₜ.

SQUID inductance is a combination of the junction inductance and the inductance of the superconducting loop. The effective inductance controlled by modulating the magnetic flux threading the junction loop can be obtained as:

$${L}_{eff} = \frac{{d ϕ}_{ext}}{{di}_{sq}} \qquad ( 6 )$$

Differentiating equation (3) with respect to iₛ

$$\frac{{d ϕ}_{ext}}{{di}_{sq}} = - {L}_{sq} + \frac{1}{{di}_{sq} / {d ϕ}_{ext}} \qquad ( 7 )$$

Differentiating equation (4) with respect to φₛ

$$\frac{{di}_{sq}}{{d ϕ}_{ext}} = - \frac{2 π {I}_{c}}{{ϕ}_{0}} cos ( \frac{2 π {ϕ}_{sq}}{{ϕ}_{0}} ) \qquad ( 8 )$$

Combining equations (5), (6), (7) and (8),

$${L}_{eff} = {L}_{sq} + \frac{{L}_{sq}}{β cos ( 2 π {ϕ}_{sq} ) / {ϕ}_{0}} \qquad ( 9 )$$

$${L}_{eff} = {L}_{sq} + {L}_{j} \qquad ( 10 )$$

where Lⱼ is the junction equivalent inductance.

$${L}_{j} = \frac{{L}_{sq}}{β cos ( 2 π {ϕ}_{sq} ) / {ϕ}_{0}} \qquad ( 11 )$$

The effective inductance of the microstrip inductor

$${L}_{m}^{′}$$

coupled to the SQUID is influenced by the change in inductance from the RF-SQUIDs and the level of mutual coupling between the inductive microstrip and the four RF-SQUIDs.

$${L}_{m}^{′} = {L}_{m} [ 1 - \frac{{K}_{1}^{2} {L}_{sq}}{{L}_{j} + {L}_{sq}} ] = {L}_{m} [ 1 - \frac{{K}_{1}^{2}}{1 + ( \frac{1}{β} cos ( \frac{2 π {ϕ}_{sq}}{{ϕ}_{0}} ) )} ]$$

In the reflective load design, the inductor L is connected in parallel with a capacitor C, with reactance X_{L} and X_{C}, respectively. The tunability in the inductance of the reflective load leads to a corresponding change in the phase of the load's reflection coefficient, enabling precise control over the phase shift.

$${X}_{L} = {ω}_{0} L ;$$

$${X}_{C} = - \frac{1}{{ω}_{0} C}$$

The tunability in the inductance of the reflective load leads to a corresponding change in the phase of the load's reflection coefficient, enabling precise control over the phase shift.

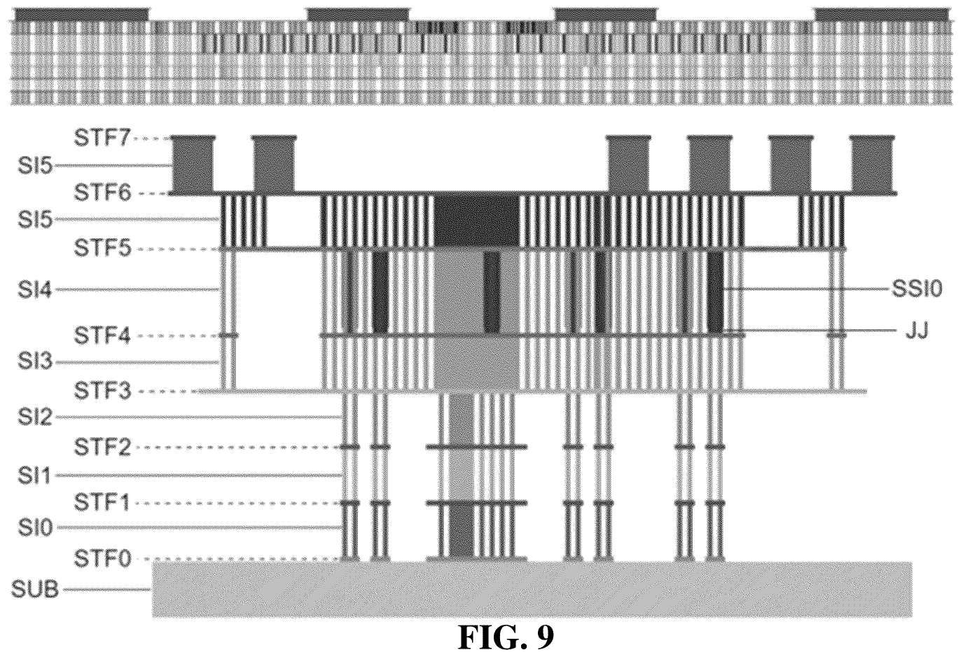

FIG. 9 shows a multilayer fabrication stack cross-section including multiple superconducting thin films (STF) connected using superconducting interconnects (SI), a short SI (SSI), current controlling resistor, and Josephson Junctions (JJ). Taking advantage of the multiple superconducting layers, the respective MIM capacitors in one implementation of the design use Josephson multiple layers.

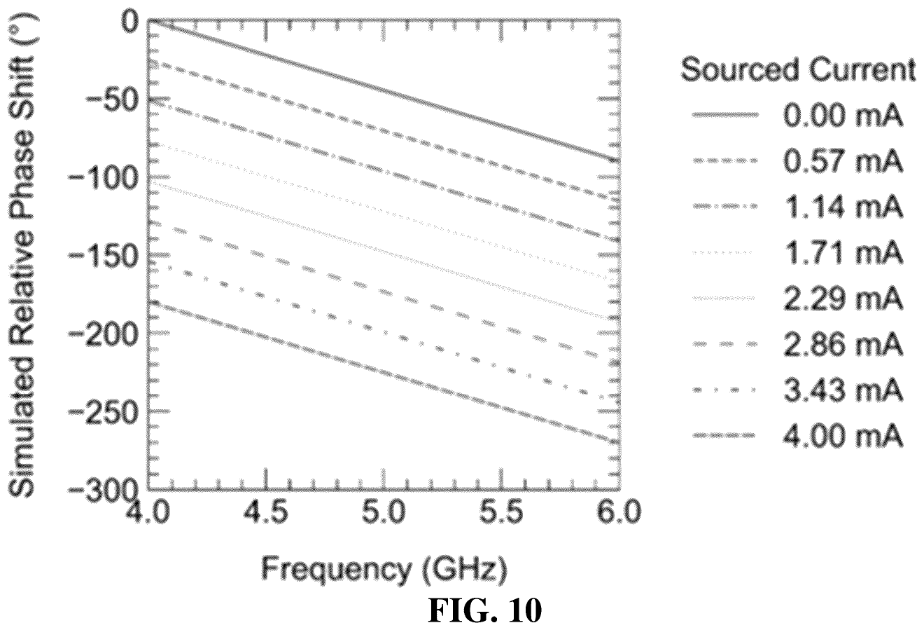

The plot in FIG. 10 illustrates the simulated relative phase shift of the example phase shifter 504 as a function of frequency, with different curves representing various sourced current levels from 0 mA to 4 mA. The plot demonstrates the phase tunability of the design, with the RF-SQUIDs providing fine control over the phase shift based on the current applied to them.

One or more example implementations and embodiments can be embodied in a system, such as described and represented herein. The system can include a microwave signal source, and a cryogenic phase shifter coupled to the microwave signal source, and coupled to a quantum bit (qubit) of a quantum processor. The cryogenic phase shifter and the qubit are incorporated within a dilution refrigerator, and the cryogenic phase shifter is controllable to apply a controlled phase shift to a microwave signal, generated by the microwave signal source, resulting in a phase-shifted microwave signal that interacts with the qubit. The system can include a detection device coupled to the qubit to detect information associated with a state of the qubit following interaction with the phase-shifted microwave signal.

The microwave signal can be a first microwave signal, the controlled phase shift can be a first controlled phase shift, the phase-shifted microwave signal can be a first phase-shifted microwave signal. The system further can include a computing device; the computing device can be coupled to the detection device to obtain the information associated with the state of the qubit, and the computing device can be coupled to the cryogenic phase shifter. The computing device can be configured to determine a second controlled phase shift based on the information associated with the state of the qubit, and apply the second controlled phase shift to a second microwave signal, resulting in a second phase-shifted microwave signal that that interacts with the qubit.

The computing device can control the phase shifter via a digital source measure unit.

The qubit can be part of a qubit chain, and the detection device can include a resonator coupled to the qubit chain. The detection device can include a signal amplifier coupled to a measurement detector device. The microwave signal can be a first microwave signal, the controlled phase shift can be a first controlled phase shift, the phase-shifted microwave signal can be a first phase-shifted microwave signal, and the system further can include a computing device; the computing device can be coupled to the measurement detector device to obtain the information associated with the state of the qubit, the computing device can be coupled to the cryogenic phase shifter, and the computing device can be configured to determine a second controlled phase shift based on the information associated with the state of the qubit, and apply the second controlled phase shift to a second microwave signal, resulting in a second phase-shifted microwave signal that that interacts with the qubit.

The qubit can include a flux qubit.

The qubit can be deployed within the dilution refrigerator at a temperature level of about ten milli-Kelvin or below.

The phase shifter can be deployed within the dilution refrigerator at a temperature level of about five Kelvin or below.

The phase shifter can be deployed within the dilution refrigerator at a temperature level of about ten milli-Kelvin or below.

The qubit can be part of a qubit chain deployed within the dilution refrigerator at a temperature level of about ten milli-Kelvin or below, the detection device can include a resonator, coupled to the qubit chain deployed within the dilution refrigerator at the temperature level of about ten milli-Kelvin or below, the detection device can include a signal amplifier coupled to the resonator, and the signal amplifier can be deployed within the dilution refrigerator at a temperature level of about thirty milli-Kelvin or below.

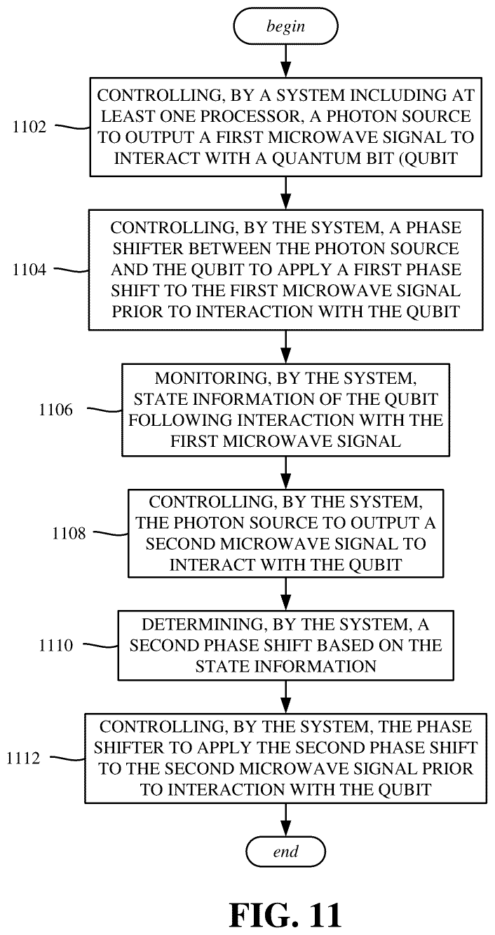

One or more example implementations and embodiments, such as corresponding to example operations of a method, can be represented in FIG. 11. Example operation 1102 represents controlling, by a system comprising at least one processor, a photon source to output a first microwave signal to interact with a quantum bit (qubit). Example operation 1104 represents controlling, by the system, a phase shifter between the photon source and the qubit to apply a first phase shift to the first microwave signal prior to interaction with the qubit. Example operation 1106 represents monitoring, by the system, state information of the qubit following interaction with the first microwave signal. Example operation 1108 represents controlling, by the system, the photon source to output a second microwave signal to interact with the qubit. Example operation 1110 represents determining, by the system, a second phase shift based on the state information. Example operation 1112 represents controlling, by the system, the phase shifter to apply the second phase shift to the second microwave signal prior to interaction with the qubit.

The state information can include a phase deviation relative to the first phase shift, and controlling the phase shifter based on the state information can include determining the second phase shift based at least in part on the phase deviation.

The state information can include noise information, and controlling the phase shifter based on the state information can include determining the second phase shift based at least in part on the noise information.

The state information can be first state information, and further operations can include monitoring, by the system, second state information of the qubit following interaction with the second microwave signal, controlling, by the system, the photon source to output a third microwave signal to interact with the qubit, determining, by the system, a third phase shift based on the second state information, and controlling, by the system, the phase shifter to apply the third phase shift to the third microwave signal prior to interaction with the qubit.

One or more example implementations and embodiments can be embodied in a system, such as described and represented herein. The system can include a computing device, a microwave photon source coupled to the computing device, a cryogenic phase shifter coupled to the computing device, coupled to the microwave photon source, and coupled to a quantum bit (qubit), and a detection device coupled to the qubit, and coupled to the computing device. The computing device can be configured to control the microwave photon source to generate a microwave signal that can be obtained by the cryogenic phase shifter, determine a controlled phase shift to be applied to the microwave signal, control the cryogenic phase shifter to apply the controlled phase shift to the microwave signal, resulting in output of a phase-shifted instance of the microwave signal for interaction with the qubit, and obtain information from the detection device, the information associated with a state of the qubit following interaction with the phase-shifted instance of the microwave signal.

The microwave signal can be a first microwave signal, the controlled phase shift can be a first controlled phase shift, the phase-shifted instance of the microwave signal can be a first phase-shifted instance of the first microwave signal, the information can be first information associated with a first state of the qubit, and the computing device can be further configured to control the microwave photon source to generate a second microwave signal that can be obtained by the cryogenic phase shifter, determine a second controlled phase shift, based on the information associated with the state of the qubit, to be applied to the second microwave signal, control the cryogenic phase shifter to apply the second controlled phase shift to the second microwave signal, resulting in output of a second phase-shifted instance of the second microwave signal for interaction with the qubit, and obtain second information from the detection device, the second information associated with a second state of the qubit following interaction with the second phase-shifted instance of the microwave signal.

The phase shifter can be deployed within a dilution refrigerator at a temperature level of five Kelvin or below.

The qubit can be part of a qubit chain, and the detection device can be coupled to the qubit via the qubit chain.

The detection device can include a resonator coupled to the qubit chain, and a signal amplifier coupled to the resonator.

As can be seen, the technology described herein includes a phase shifter operating at cryogenic temperatures, which minimizes thermal noise and allows precise phase control for quantum gate operations. This ensures better alignment of microwave signals with the qubits and improves overall qubit stability. The classical control system described herein, including the ADC, DAC, and HPC server/cluster, which monitors the quantum operations in real-time, dynamically adjusts control parameters based on feedback from the qubits, and thereby mitigates phase noise and optimizes qubit performance without introducing additional noise or latency. This is in contrast to traditional designs for phase control in quantum circuits that do not adapt to dynamic changes in the quantum environment. Indeed, as phase errors develop over time, existing systems do not provide real-time adjustments to compensate for phase deviations, which causes the quantum system's performance to degrade over extended operations; qubit operations in existing systems are vulnerable to phase noise and signal drift, as errors are only reactively corrected after they have already adversely impacted the system. Instead, the technology described herein enables real-time detection and correction of phase misalignments, mitigating phase noise errors, which results in enhanced qubit coherence and improved fidelity in quantum gate operations.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a microwave signal source;
a cryogenic phase shifter coupled to the microwave signal source, and coupled to a quantum bit (qubit) of a quantum processor, wherein the cryogenic phase shifter and the qubit are incorporated within a dilution refrigerator, and wherein the cryogenic phase shifter is controllable to apply a controlled phase shift to a microwave signal, generated by the microwave signal source, resulting in a phase-shifted microwave signal that interacts with the qubit; and
a detection device coupled to the qubit to detect information associated with a state of the qubit following interaction with the phase-shifted microwave signal.

2. The system of claim 1, wherein the microwave signal is a first microwave signal, wherein the controlled phase shift is a first controlled phase shift, wherein the phase-shifted microwave signal is a first phase-shifted microwave signal, and further comprising a computing device, wherein the computing device is coupled to the detection device to obtain the information associated with the state of the qubit, wherein the computing device is coupled to the cryogenic phase shifter, and wherein the computing device is configured to:
determine a second controlled phase shift based on the information associated with the state of the qubit; and
apply the second controlled phase shift to a second microwave signal, resulting in a second phase-shifted microwave signal that that interacts with the qubit.

3. The system of claim 2, wherein the computing device controls the phase shifter via a digital source measure unit.

4. The system of claim 1, wherein the qubit is part of a qubit chain, and wherein the detection device comprises a resonator coupled to the qubit chain.

5. The system of claim 4, wherein the detection device comprises a signal amplifier coupled to a measurement detector device.

6. The system of claim 5, wherein the microwave signal is a first microwave signal, wherein the controlled phase shift is a first controlled phase shift, wherein the phase-shifted microwave signal is a first phase-shifted microwave signal, and further comprising a computing device, wherein the computing device is coupled to the measurement detector device to obtain the information associated with the state of the qubit, wherein the computing device is coupled to the cryogenic phase shifter, and wherein the computing device is configured to:
determine a second controlled phase shift based on the information associated with the state of the qubit; and
apply the second controlled phase shift to a second microwave signal, resulting in a second phase-shifted microwave signal that that interacts with the qubit.

7. The system of claim 1, wherein the qubit comprises a flux qubit.

8. The system of claim 1, wherein the qubit is deployed within the dilution refrigerator at a temperature level of about ten milli-Kelvin or below.

9. The system of claim 1, wherein the phase shifter is deployed within the dilution refrigerator at a temperature level of about five Kelvin or below.

10. The system of claim 1, wherein the phase shifter is deployed within the dilution refrigerator at a temperature level of about ten milli-Kelvin or below.

11. The system of claim 1, wherein the qubit is part of a qubit chain deployed within the dilution refrigerator at a temperature level of about ten milli-Kelvin or below, wherein the detection device comprises a resonator, coupled to the qubit chain deployed within the dilution refrigerator at the temperature level of about ten milli-Kelvin or below, wherein the detection device comprises a signal amplifier coupled to the resonator, and wherein the signal amplifier is deployed within the dilution refrigerator at a temperature level of about thirty milli-Kelvin or below.

12. A method, comprising:
controlling, by a system comprising at least one processor, a photon source to output a first microwave signal to interact with a quantum bit (qubit);
controlling, by the system, a phase shifter between the photon source and the qubit to apply a first phase shift to the first microwave signal prior to interaction with the qubit;
monitoring, by the system, state information of the qubit following interaction with the first microwave signal;
controlling, by the system, the photon source to output a second microwave signal to interact with the qubit;
determining, by the system, a second phase shift based on the state information; and
controlling, by the system, the phase shifter to apply the second phase shift to the second microwave signal prior to interaction with the qubit.

13. The method of claim 12, wherein the state information comprises a phase deviation relative to the first phase shift, and wherein the controlling of the phase shifter based on the state information comprises determining the second phase shift based at least in part on the phase deviation.

14. The method of claim 12, wherein the state information comprises noise information, and wherein the controlling of the phase shifter based on the state information comprises determining the second phase shift based at least in part on the noise information.

15. The method of claim 12, wherein the state information is first state information, and further comprising:
monitoring, by the system, second state information of the qubit following interaction with the second microwave signal;
controlling, by the system, the photon source to output a third microwave signal to interact with the qubit;
determining, by the system, a third phase shift based on the second state information; and
controlling, by the system, the phase shifter to apply the third phase shift to the third microwave signal prior to interaction with the qubit.

16. A system, comprising:
a computing device;
a microwave photon source coupled to the computing device;
a cryogenic phase shifter coupled to the computing device, coupled to the microwave photon source, and coupled to a quantum bit (qubit); and
a detection device coupled to the qubit, and coupled to the computing device,
wherein the computing device is configured to:
control the microwave photon source to generate a microwave signal that is obtained by the cryogenic phase shifter,
determine a controlled phase shift to be applied to the microwave signal,
control the cryogenic phase shifter to apply the controlled phase shift to the microwave signal, resulting in output of a phase-shifted instance of the microwave signal for interaction with the qubit, and
obtain information from the detection device, the information associated with a state of the qubit following interaction with the phase-shifted instance of the microwave signal.

17. The system of claim 16, wherein the microwave signal is a first microwave signal, wherein the controlled phase shift is a first controlled phase shift, wherein the phase-shifted instance of the microwave signal is a first phase-shifted instance of the first microwave signal, wherein the information is first information associated with a first state of the qubit, and
wherein the computing device is further configured to:
control the microwave photon source to generate a second microwave signal that is obtained by the cryogenic phase shifter,
determine a second controlled phase shift, based on the information associated with the state of the qubit, to be applied to the second microwave signal,
control the cryogenic phase shifter to apply the second controlled phase shift to the second microwave signal, resulting in output of a second phase-shifted instance of the second microwave signal for interaction with the qubit, and
obtain second information from the detection device, the second information associated with a second state of the qubit following interaction with the second phase-shifted instance of the microwave signal.

18. The system of claim 16, wherein the phase shifter is deployed within a dilution refrigerator at a temperature level of five Kelvin or below.

19. The system of claim 16, wherein the qubit is part of a qubit chain, and wherein the detection device is coupled to the qubit via the qubit chain.

20. The system of claim 19, wherein the detection device comprises a resonator coupled to the qubit chain, and a signal amplifier coupled to the resonator.
